(19) United States
(12) Patent Application Publication
(10) Pub. No.: US 2012/0090370 A1
(43) Pub. Date: Apr. 19, 2012

(54) METHOD AND APPARATUS FOR BENDING COMPOSITE REINFORCED PIPE

(75) Inventor: Norman C. Fawley, Cayucos, CA (US)

(73) Assignee: NCF INDUSTRIES, INC., Cayucos, CA (US)

(21) Appl. No.: 13/334,717

(22) Filed: Dec. 22, 2011

Related U.S. Application Data
(63) Continuation of application No. 10/695,252, filed on Oct. 27, 2003, now abandoned.

(51) Int. Cl. B21D 7/06; H05B 6/10; B21D 7/16

(52) U.S. Cl. 72/19.5; 72/342.1; 219/602

(57) ABSTRACT

An induction heater is used to heat composite reinforced pipe (CRP) prior to a bending operation. By heating the composite reinforcement to approximately 90° F.-110° F., the incidence of circumferential stress cracks in the resin is significantly reduced. Resin cracking is also reduced by incorporating longitudinal fibers in the composite reinforcement during manufacture of CRP.

### CROSS-REFERENCE TO RELATED APPLICATION

This application is a continuation of U.S. application Ser. No. 10/695,252, filed Oct. 27, 2003.

### BACKGROUND OF THE INVENTION

1. Field of the Invention

The present invention relates generally to the field of composite reinforced pipe (CRP), which is used for gas and oil transmission pipelines. More particularly, the invention relates to a method and apparatus for bending CRP without cracking or delamination of the composite reinforcement.

2. Background

Gas and oil transmission pipelines are typically constructed with large diameter pipe buried below ground. During construction, the pipe segments must be bent to follow terrain contours. Pipe bending is typically done on site with a special-purpose bending machine. Conventional steel pipe is sufficiently ductile so that it can be bent to follow terrain contours without damaging the structural integrity of the pipe.

Composite reinforced pipe (CRP) is more difficult to bend in comparison to non-reinforced steel pipe. The composite reinforcement, which is generally a fiberglass-reinforced resin, is prone to surfacing/laminate cracking during the bending process. Such cracking allows moisture to penetrate the composite reinforcement. Unless the cracks are sealed, which can be a tedious and time-consuming process, the structural integrity of the pipe is likely to be compromised over time by the incursion of moisture. Resin cracking is more pronounced at lower temperatures and is therefore a significant problem in arctic environments.

### SUMMARY OF THE INVENTION

The present invention utilizes a heater to heat Composite Reinforced Pipe (CRP) at a location where it is to be bent. The heater is placed around the CRP in line with an otherwise conventional bending machine. The composite reinforcement is heated to slightly below the heat distortion temperature (HDT) of the resin in the composite reinforcement, which allows the CRP to be bent without cracking the resin. Resin cracking is also reduced by incorporating fibers substantially longitudinal to axis of pipe, i.e., parallel, in the composite reinforcement during manufacture of CRP and by reducing the bend per pull.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a schematic view of a pipe-bending apparatus implementing one embodiment of the invention.

FIG. 2 illustrates construction of a composite reinforced pipe with longitudinal reinforcing fibers.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

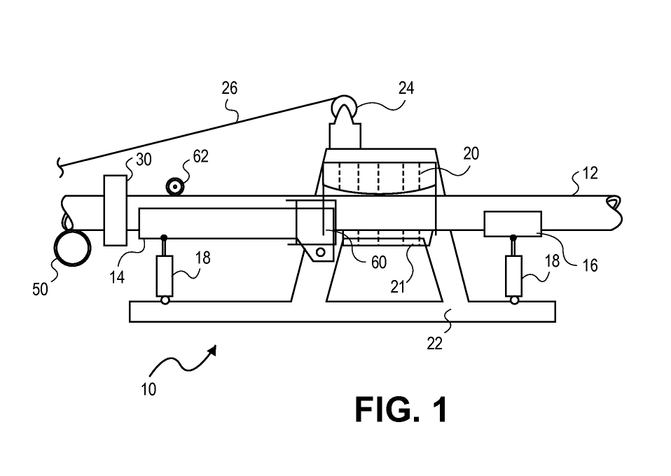

Referring to FIG. 1, the present invention may be implemented in combination with a pipe-bending machine shown generally as 10. One source of such a bending machine is CRC—Evans Pipeline International, Inc., of Tulsa, Okla. A section of pipe 12 is supported by stiffback 14 and pin up shoe 16. In a typical bending machine, stiffback 14 and pin up shoe 16 are each moveably mounted on frame 22 and are positioned by means of hydraulic cylinders 18. A die 20 is rigidly mounted on frame 22 of bending machine 10.

To place a bend in pipe 12, stiffback 14 and pin up shoe 16 are elevated by hydraulic cylinders 18 until the pipe is in contact with the surface of die 20. Additional forces are then applied through the hydraulic cylinder supporting stiffback 14 to bend pipe 12 around the curved surface of die 20. In one embodiment, segmented die 21 is mounted on a pipe bending machine 10 to support the underside of the pipe 12 at the bend. The segmentation allows the die to more closely follow the bend of the pipe 12. Each segment may be independently hydraulically controlled. A mandrel (not shown) is typically placed within pipe 12 and positioned at the point of contact with die 20 to support the inner wall of the pipe so that the circular cross-section of the pipe is not distorted during the bending operation. Conventional steel pipes are typically bent in increments typical one degree of bend per pipe diameter of length at several locations separated by a distance approximately equal to the diameter of the pipe until the desired angle of bend is achieved. Thus, for a 24″ diameter pipe one degree of bend will be made every 24″ until a desired bend is reached. In one embodiment of the invention, the frequency of bend is increased, but the degree of bend is reduced. For example, in one embodiment, a 24″ diameter pipe will be bent ¼° every 6″. Thus, four bends will occur in one pipe diameter resulting in ¼° of bend every ¼° diameter. This is effectively a reduction in the bend per pull and correspondingly the strain within the composite reinforcement. It should be recognized that the diameter, grade of pipe, pipe wall thickness, and the yield tensile ratio of the pipe, effect the amount of bend possible. Thus, for thick walled pipe, a maximum bend may be less than 1° per pipe diameter.

The pipe is positioned longitudinally within bending machine 10 by a winch 24 and a cable 26 attached to one end of the pipe section. Alternatively, the bending machine may incorporate a system of powered rollers 50 that positions the pipe section longitudinally. Powered roller 50 permits the pipe to be moved longitudinally in either direction. An indexing wheel 62 may be provided to track the longitudinal traversal of the pipe. The indexing wheel 62 may provide input to a control unit 60, which may include a microprocessor, an application specific integrated circuit or other processing element.

In the case of CRP, bending a section of pipe at ambient temperature is likely to produce circumferential stress cracks in the resin of the composite reinforcement on the tension side of the bend. However, such cracking generally does not occur if the resin is heated to a temperature of about its heat distortion temperature (HDT). Therefore, the present invention utilizes an induction heater 30 placed around pipe 12 at the bending machine 10. The induction heater 30 is controlled to heat the steel core of the CRP to a temperature above the HDT of the resin. As a result, the composite reinforcement is heated to a temperature slightly below its HDT owing to the relatively poor thermal conductivity of the composite. Once the pipe has been heated to the desired temperature, the pipe is advanced to place the heated portion directly below die 20 and the bending operation is commenced. In one embodiment, it takes four to five minutes for the composite reinforcement to reach the described temperature and the heating occurs 7′ -10′ from the die 20. In one embodiment, incremental bends are made at locations separated by a distance of about ¼ of the pipe diameter (rather than the full diameter as is typical for conventional steel pipe). In experimental tests, the present invention has been successfully employed to bend 24-inch diameter CRP in ambient conditions of −20° F. without cracking. In one embodiment, prior to commencing the bending operation, the CRP is preheated by introducing hot air into the pipe. This improves the efficiency of the induction heating, by in part decreasing the temperature difference between the portion of the pipe to be bent and the adjacent portions of the pipe. In one embodiment, die 20 is segmented allowing it to more closely follow the bend.

During the heating and bending process, the ends of pipe section 12 are preferably capped to prevent the flow of air through the pipe and thereby reduce heat loss to the outside environment. Simple cardboard caps are sufficient for this purpose. A small aperture can be provided in the cap to provide a pass-through for a reach rod to operate the internal mandrel.

Circumferential cracking of the composite reinforcement of CRP can also be reduced by modifying the structure of the composite reinforcement. The composite reinforcement is typically applied to the steel pipe core by winding fiberglass filaments around the pipe as it is rotated. In other embodiments, carbon fiber or other suitable fiber may be used in the composite reinforced. The filaments pass through a resin bath as they are wound on the pipe. Alternatively, resin preimpregnated fibers (prepreg) may be used. The circumferential orientation of the fiberglass filaments increases the hoop strength of the pipe; however, there is no longitudinal reinforcement of the resin. Hence, the resin is prone to developing circumferential cracks under stress.

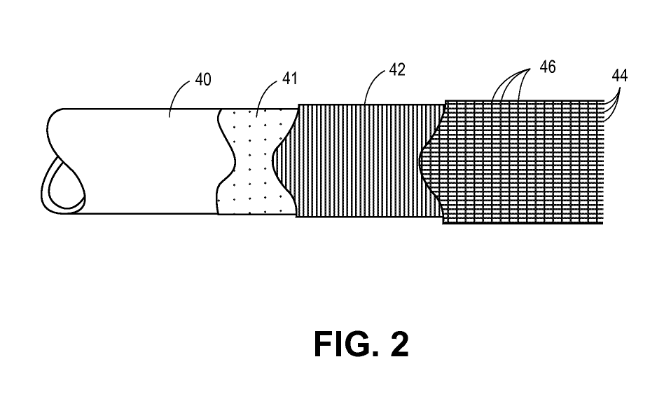

FIG. 2 illustrates a modified construction of CRP to reduce the incidence of circumferential cracking. A steel pipe may be shot blasted to clean and provide an anchor pattern to facilitate the adhesion of the composite reinforcement. A steel pipe core 40 is covered with a primer layer 41. The primed pipe is then circumferentially wrapped with a fiber-reinforced resin matrix 42 as is known. In addition, longitudinal fibers 44 are wrapped over and/or within the circumferential fiber-reinforced matrix 42. This may be accomplished by applying a woven roving having both longitudinal (weft) fibers 44 and circumferential (warp) fibers 46. A suitable woven roving for this application is 80% weft/20% warp. Woven roving with 50% weft/50% warp could also be used. Alternatively, a indirectional weft fabric, a ±90° stitched fabric or a ±45° stitched fabric may be used. The weft fibers provide longitudinal reinforcement of the resin and thereby significantly reduce the incidence of circumferential cracking. In one embodiment, the fabrics barber poled onto the pipe such that in practice the weft fibers are at an angle of about 45° to the longitudinal axis of the pipe. In such embodiment, use of ±45° fabric resulting in truly longitudinal fibers. The angle of application also depends on roll width.

As explained above, cracking of the composite reinforcement of a CRP during bending is reduced or eliminated by heating the resin. Resin elongation increases with temperature. It has been found that an elongation factor of about 20% is required to successfully bend CRP 1% per pipe diameter without inducing cracks in the resin. The amount by which the temperature of the resin must be elevated to achieve 20% elongation is, of course, influenced by the ambient temperature as well as the characteristics of the resin. Thus, it is desirable to match the resin characteristics to the environment in which the CRP is to be installed and used. Specifically, the resin should be selected to have a heat distortion temperature appropriate for the environment, e.g., arctic or tropical.

Table 1 shows resins suitable for arctic, temperate an high temperature environments:

TABLE 1

| Ambient | | | | |
|---|---|---|---|---|
| Temp | | | | |
| Range (° F.) | Resin | PSI | HDT | Elongation |
| −20°-60° | 1333 | 2500 | 100° F. | 30% |
| 60°-100° | 737 | 8000 | 176° F. | 4% |
| 100°-150° | 701 | 10,000 | 224° F. | 2.5% |

All of these resins are commercially available from AOC Corporation of Collierville, Tenn. As reflected in the table, there is an inverse correlation between modular strength and elongated and a positive correlation between HDT and modular strength. While these three resins are suitable for the ambient temperature ranges indicated, other resins and more granular ranges are within the scope and contemplation of the invention.

In the foregoing specification, the invention has been described with reference to specific embodiments thereof. It will, however be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. An apparatus for bending a section of composite reinforced pipe comprising:
a frame;
a die mounted on the frame;
a pin up shoe for securing the section of pipe against the die;
a stiffback movably mounted on the frame for bending the section of pipe against the die;
a heater for elevating the temperature of the section of pipe; and
means for longitudinally positioning the section of pipe in the apparatus.

2. The apparatus of claim 1 wherein the heater is an induction heater.

3. The apparatus of claim 2 wherein the heater encircles the section of pipe.

4. The apparatus of claim 1 wherein the die is segmented.

5. The apparatus of claim 1 further comprising:
an indexing wheel; and
a controller to activate the die responsive to the indexing wheel.

6. The apparatus of claim 1 wherein the means for longitudinally positioning comprising:
a powered roller to translate the pipe in either a forward or reverse direction.
